(19) United States
(12) Patent Application Publication
(10) Pub. No.: US 2002/0125180 A1
(43) Pub. Date: Sep. 12, 2002

(54) Process of catalytic electrochemistry waste water treatment and the apparatus thereof

(76) Inventor: Jian-Tsarng Lin, Taipei Hsien (TW)

Correspondence Address: BACON & THOMAS, PLLC, 625 Slaters Lane - 4th Floor, Alexandria, VA, 22314-1176, US

(21) Appl. No.: 09/756,754

(22) Filed: Jan. 10, 2001

(51) Int. Cl. C02F 1/00

(52) U.S. Cl. 210/192; 210/748

(57) ABSTRACT

A process of catalytic electrochemistry waste water treatment and the apparatus thereof are provided. The apparatus includes a waste water tank, a collecting tank, a treatment tank, at least one positive electrode plate and at least one negative electrode plate, at least one catalyst, and an air unit. By way of filling the catalyst and introducing current and air into the treatment tank, Hydrogen Peroxide (H₂O₂) is produced in the treatment tank, and which reacts with Ferrous ions dissolved in the treatment tank, to rapidly generate a certain quantity of Hydroxyl radicals (·OH), so as to degrade or mineralize the organic compounds in the waste water to CO₂ and H₂O.

### BACKGROUND OF THE INVENTION

1. Field of the Invention

The present invention relates to a process for treating waste water and the apparatus thereof, and more particularly to a process of catalytic electrochemistry waste water treatment and the apparatus thereof by way of producing Hydroxyl radicals to degrade or mineralize organic compounds in the waste water.

2. Description of the Prior Art

In the trend of worldwide environmental protection and requirement of the future green globe village, it is one of the primary issues to resolve environmental problems accompanying with various kinds of industrial developments. Hence, with respect to the contamination sources resulting in environmental contamination, such as waste water, waste products, etc, discharged by the industries having serious contamination, the government has taken strict control and punishment actions. At the same time, the government, experts and scholars also actively study and develop the methods for improving environment, organize and invest equipments and cost to improve environment, and enhance measures for contamination punishment.

In the respect of current techniques for waste water treatment in the industries, the organic and nitrogen-contained contaminant (for example, ammoniacal nitrogen, organic nitrogen, etc.) in the industrial waste water are removed by way of various biological oxidation, physical, and chemical treatment process. The waste water treatment methods include Fenton process, biological treatment process, and physical/chemical treatment process, etc.

However, there are some problems encountered in the present plants for treating waste water and the equipment thereof, as following:

1. The legal standard requirement for outlet water is not attained. The recent research for industrial waste water treatment is concentrated on AOPs' Fenton process, which dosing Hydrogen Peroxide and Ferrous Sulfate to facilitate producing Hydroxyl radicals in the reaction to degrade organic contaminants. The reaction formula is as following:

H₂O₂+Fe²⁺→Fe³⁺+HO⁻+HO·

Although the above process involves the electrochemistry waste water treatment method, the treatment for the dye manufacturing waste water were still very difficult to attain the legal COD requirement for outlet water. Besides, the factors for constantly dosing H₂O₂ and FeSO₄, high cost for treatment, and worry about H₂O₂ storages safety which make the investors' indetermination and doubtfulness.

2. The treatment process is too complicated and inconvenient for operation. The biological treatment process takes about 12 to 24 hours or more. They are not only inconvenience, occupying large area, wasting time, but also producing smell and mosquito and flies during treatment.

3. It is difficult to decompose partly tough compounds by the biological treatment process, especially the high density electron clouds compounds. Therefore, the types of treatable waste water are limited.

4. It is not easy for operation and maintenance. There are many processing units used in the conventional treatment process. The maintenance cost is high. Moreover, the mechanical devices in the system may be corroded by the strong acid and strong alkali used in the chemical treatment process.

5. The equipment setup cost and operating cost are high. For example, it is necessary for the chemical treatment process to consume a quite quantity of chemical compounds.

6. The function of the treatment system could not be upgraded during the factory expansion due to the space limitation. The treatment limitation is there, and thus the treatment effect always could not be satisfied by the legal requirement.

### SUMMARY OF THE INVENTION

It is one objective of the invention to provide a process of catalytic electrochemistry waste water treatment and the apparatus thereof, wherein the catalyst is contained in a treatment tank, and current and air are introduced into the treatment tank, so that Hydrogen Peroxide (H₂O₂) is produced and reacts with Ferrous ions dissolved therein to rapidly produce a certain quantity of Hydroxyl radicals to degrade or mineralize organic compounds in waste water into CO₂ and H₂O. It is not necessary to dose Hydrogen Peroxide and Ferrous Sulfate, and also not necessary to continuously dose the catalyst and recover it. Therefore, the life cycle of the catalyst is extended. The treatment process became easy, and the reaction time and cost is significantly reduced.

It is another objective of the invention to provide a broadly useful process of catalytic electrochemistry waste water treatment and the apparatus thereof, in which for the different components in the waste water, respectively selecting different catalysts with high effective catalysis therefor and properly adjust controlling parameters.

It is a further objective of the invention to provide a process of catalytic electrochemistry waste water treatment and the apparatus thereof, which could treat waste water in a quite limited space.

### BRIEF DESCRIPTION OF THE DRAWINGS

FIG. 1 is a flow chart of the process in accordance with the present invention;

FIG. 2 is a schematic view of showing the apparatus according to the present invention;

FIG. 3 is a schematic cross-sectional view of a treatment tank of the apparatus of FIG. 2;

FIG. 4 is a schematic view illustrating treatment process in the treatment tank of FIG. 2; and

FIG. 5 is a schematic view of apparatus with the function of repeat treatments.

### DESCRIPTION OF THE PREFERRED EMBODIMENTS

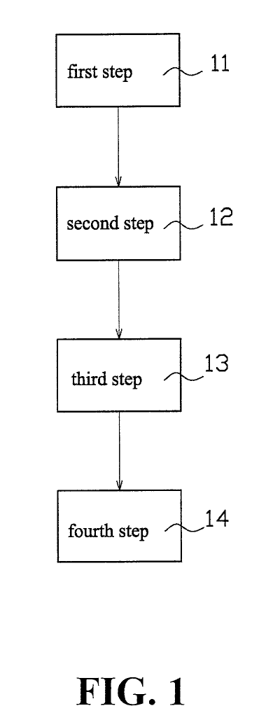

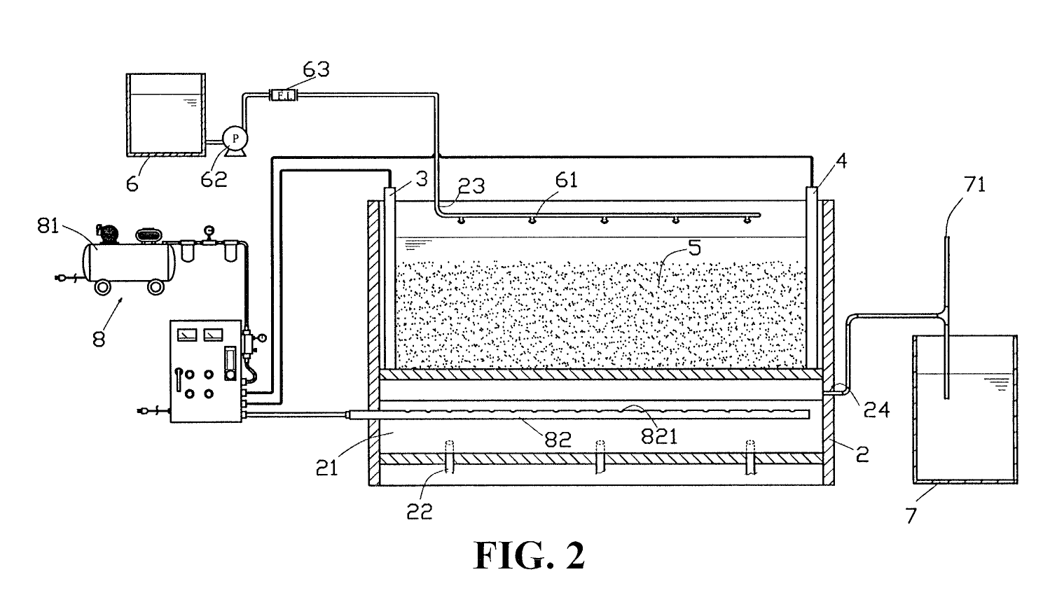

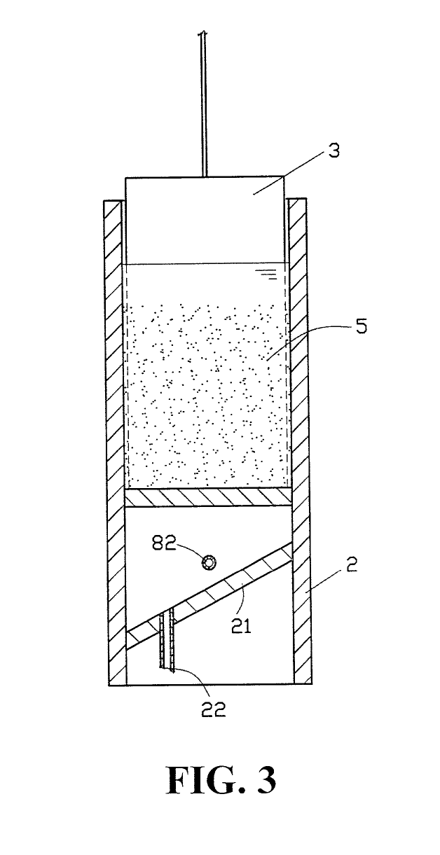

Referring to FIG. 1 to FIG. 4, the present catalytic electrochemistry waste water treatment apparatus, as shown in FIG. 2 and FIG. 3, includes:

a treatment tank 2, having a predetermined dimension to contain waste water, inclined plate 21 is positioned in the bottom of the treatment tank 2, a plurality of waste outlet pipes are respectively located on the predetermined positions of the inclined plate 21 to discharge suspended solids produced after reaction;

at least one positive electrode plate 3 and one negative electrode plate 4, both of which have conductivity, the positive electrode plate 3 and the negative electrode plate 4 are respectively disposed in predetermined positions in the treatment tank 2, the largest distance between the positive electrode plate 3 and the negative electrode plate 4 is 1.2 meters, and the electrode plates 3 and 4 are respectively connected with electrical power source and rectifier to conduct positive and negative electricity current;

at least one catalyst 5, filled in the treatment tank 2, at least one water inlet 23, and at least one water outlet 24 are respectively disposed above and below the catalyst 5 in the treatment tank 2;

a waste water tank 6, provided for containing waste water to be treated, which is connected with the water inlet 23 in the treatment tank 2, a water inlet spreading tube 61 is positioned in the inlet water travel end, and a waste water pump 62 pumps waste water into the treatment tank 2, a flow meter 63 is set to control water flow;

a collecting tank 7, provided for containing treated outlet water, which is connected with the water outlet 24 of the treatment tank 2, and a siphon breaking device 71 is disposed in the outlet water travel end, so as to conveniently discharge water and prevent siphon effect between the tanks;

an air unit 8, including an air compressor 81 and an air tube 82, the air tube 82 is disposed in the treatment tank 2 and below the catalyst 5, a plurality of diffusers 821 are disposed on the air tube 82, the diameter and distribution of the diffusers 821 are coordinated with the treatment tank 2.

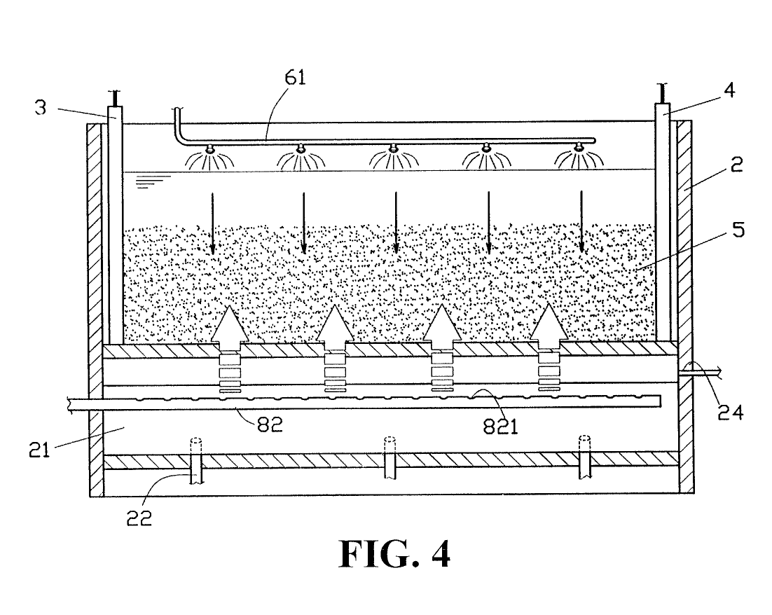

In the present embodiment, the water inlet 23 is disposed in the top of the treatment tank 2, and the water outlet 24 and the air tube 82 are disposed in the bottom of the treatment tank 2. As shown in FIG. 4, the waste water flows downward from the top of the treatment tank 2 and the air moving upward from the bottom of the treatment tank 2, so that attaining sufficient contact between the waste water and the air. Finally, the treated waste water flows into the collecting tank 7 through the water outlet 24. The colloidal solids, produced after the reaction, are discharged from the waste pipe 22 disposed in the inclined plate 21 of the treatment tank 2.

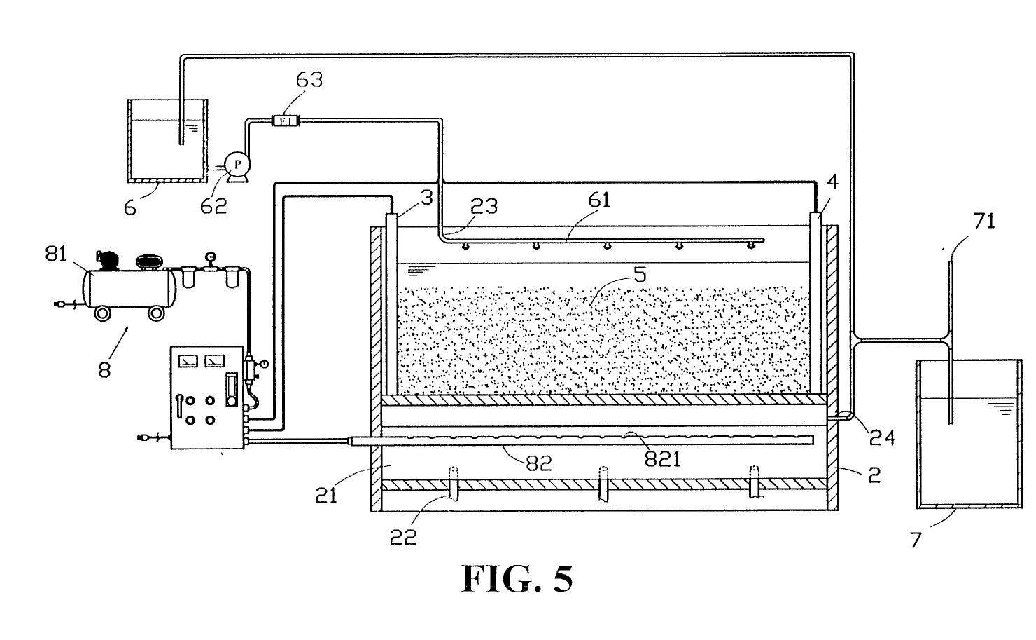

However, the present invention is not limited to the above embodiment. The repeat waste water treatment and the steps subsequent to the waste water treatment are performed depending on the water quality of the treated outlet water. FIG. 5 depicts a repeated waste water treatment, which shows the treated water flows back to the waste water tank 6.

The present catalytic electrochemistry waste water treatment includes following steps, as shown in FIG. 1:

first step 11: the catalyst 5 is filled in the treatment tank 2, and the waste water is filled into the treatment tank 2 from the waste water tank 6, and the waste water is pre-adjusted the pH value before treatment;

second step 12: the positive electrode plate 3 and the negative electrode plate 4 are disposed in the treatment tank 2 and conducted with current, and air is fed into the air tube 82 and diffusers 821 of the treatment tank 2;

third step 13: Hydrogen Peroxide (H₂O₂) produced in the treatment tank 2 reacts with Ferrous ions dissolved in the treatment tank 2 to rapidly generate a certain quantity of Hydroxyl radicals (·OH) to degrade or mineralize organic compounds in the industrial waste water to CO₂ and H₂O; the Ferrous ions dissolved in the treatment tank 2 is obtained by way of electrochemistry action of the positive electrode plate 3 or the catalyst 5 dissolving; and

fourth step 14: the treated water is fed into the collecting tank 7 from the treatment tank 2.

In the present invention, by way of introducing air and current into the treatment tank 2, Hydrogen Peroxide is produced in the treatment tank 2, and which reacts with the dissolved Ferrous ions produced from the catalyst 5 in the treatment tank 2 to rapidly generate a certain quantity of Hydroxyl radicals (·OH) with strong oxidation ability, so as to degrade and even completely mineralize the organic compounds in the waste water to CO₂ and H₂O. The reaction formula is as follows:

O₂+e−→O₂_{⁻}

O₂_{⁻}+H⁺→HO₂

2HO₂→H₂O₂+O₂

O₂_{⁻}+HO₂→O₂+HO₂_{⁻}

HO₂_{⁻}+H+→H₂O₂

H₂O₂+e−→HO−+HO·

H₂O₂+Fe²⁺→Fe³⁺+HO·+OH⁻

It should be noted, it is able to produce Hydroxyl radicals (·OH) by way of introducing air, current and fill the catalyst 5, without dosing the Fenton reagents such as Hydrogen Peroxide and Ferrous Sulfate, to degrade the organic compounds. That is, the air, current and catalyst 5 are used as the driving force to decompose and oxidize the organic waste water instead of the related reagents such as H₂O₂ and FeSO₄. Comparing with the conventional Fenton process, the operation cost of the present invention is reduced to be about one half to one third.

The present invention is described and explained by embodiments of waste water of the dye manufacturing factory, textile process and the leachate of the garbage land filled area.

In the first embodiment, the waste water from the dye manufacturing factory is performed COD and colority-removing treatment.

Firstly, the waste water from a known dye manufacturing factory is served as the treatment subject to proceed the test for removing organic compounds with high COD concentration, high colority and high Chloride content. After proceeding test with different parameters in laboratory scale several times, the water quality results obtained by the statistical method are listed in the table I.

Table I is water quality result using the waste water from a known
dye manufacturing factory as the treatment subject

| Analysis terms | Data |
|---|---|
| waste water quantity for treatment | 5 |
| (L/hr) | |
| Hydraulic retention time (HRT)[hr] | 2.0 |
| inlet water COD average | 9600˜14815 |
| concentration [mg/L] | |
| outlet water COD average | 2020˜5365 |
| concentration [mg/ L] | |
| COD average removing ratio [%] | 63˜79% |
| chloride average concentration in | 25000˜45000 |
| the inlet water [mg/L] | |
| inlet water colority [ADMI] | 201062˜142383 |
| outlet water colority [ADMI] | 6143˜3982 |
| colority removing ratio [%] | (about) 97% |

It is known from the table I, with respect to the waste water from the dye manufacturing factory, the COD removing ratio attains about 63˜79%, and the colority removing ratio attains at least about 95%, for the present invention. Therefore, the present invention could obtain quite high COD removing ratio and colority removing ratio.

In the second embodiment, the waste water from textile process is used as the treatment subject to proceed COD and colority removing treatment. After proceeding test with different parameters in laboratory scale several times, the water quality results obtained by the statistical method are listed in the table II

Table II is water quality results using the waste water from textile
process as the treatment subject

| analysis terms | Data |
|---|---|
| waste water quantity for treatment | 10 |
| (L/hr) | |
| Hydraulic retention time (HRT)[hr] | 1 |
| Inlet water COD average | 339˜1834 |
| concentration [mg/L] | |
| Outlet water COD average | 89˜360 |
| concentration [mg/L] | |
| COD average removing ratio [%] | 73˜80% |
| Inlet water colority [ADMI] | 1475˜945 |
| Outlet water colority [ADMI] | 436˜343 |
| colority removing ratio [%] | 63˜70% |

It is known from the table II, with respect to the waste water from the textile process, the COD removing ratio attains about at least 70%, and the colority removing ratio attains at least about 63%, for the present invention. Therefore, the present invention could obtain quite high COD removing ratio and colority removing ratio.

In the third embodiment, with respect to the leachate waste water from the garbage land filled area, proceeding COD contaminant removing treatment. After proceeding test with different parameters in laboratory scale several times, the water quality results obtained by the statistical method are listed in the table III.

Table III is water quality results using the leachate waste water
from the garbage land filled area as the treatment subject

| analysis terms | Data |
|---|---|
| waste water quantity for treatment | 5 |
| (L/hr) | |
| Hydraulic retention time (HRT) [hr] | 2.0 |
| inlet water COD average | 6594˜1306 |
| concentration [mg/L] | |
| outlet water COD average | 2688˜230 |
| concentration [mg/L] | |
| COD average removing ratio [%] | 59˜82% |

It is known from the table III, with respect to the leachate waste water from the garbage land filled area, the COD removing ratio attains about 59˜82% for the present invention. Therefore, the present invention could obtain quite high COD removing ratio.

Thus, in the present invention, by way of introducing air and current into the catalyst 5 filled treatment tank 2, Hydrogen Peroxide is produced in the treatment tank 2, and which reacts with the dissolved Ferrous ions in the treatment tank 2 to rapidly generate a certain quantity of Hydroxyl radicals (·OH), so as to degrade and mineralize the organic compounds in the waste water to CO₂ and H₂O. The present invention provides advantages as follows:

1. It is not necessary to dose Hydrogen Peroxide and Ferrous Sulfate to facilitate the reaction. With respect to different components in the waste water, different kinds of catalyst 5 with respective high effective to each of the different components, such as a catalyst 5 having high alloy component (dye manufacturing and textile waste water) and a catalyst 5 having low alloy component (paper-milling or semiconductor waste water), etc, are selected. It is not necessary to continuously dose or recover the catalyst 5, so that the life cycle of the catalyst 5 is extended, the cost of the waste water treatment is reduced, and the second contamination is also eliminated.

2. H₂O₂ (·OH) and Ferrous ions are produced and effectively left in the treatment tank 2 by way of properly controlling the parameters (inlet pH, gas/liquid ratio, current, voltage, reaction time, reaction batches, etc). The high effective oxidation conditions are obtained without dosing the related reagents of H₂O₂ and FeSO₄, and the effectiveness of the treatment process is improved. The treatment takes about 15 minutes to 3 hours, 6 hours at most, depending on the COD value. Hence, the reaction time is significantly reduced, and the effectiveness of the treatment process is improved. After proceeding the reaction for a certain time, little sludge produced during the reaction could be discharged from the waste pipe 22, and avoiding the clogging phenomenon happening in the catalyst 5.

3. The present invention followed by the latter-stage chemical method makes the waste water treatment of the industries easily attain the national standard COD requirement for outlet water.

4. It is easy to perform the treatment, and the treatment process does not produce smell and mosquito and flies. Both of operation and maintenance are easy. Moreover, the inclined plate 21 and the waste pipe 22 of the treatment tank 2 facilitate to discharge the sludge, so as to prevent the flow path from clogging.

5. The present invention could treat the tough waste water such as dye manufacturing, textile, paper-milling, leachate from the garbage, semiconductor waste water, etc, and could decompose chemical bonds which the biological treatment method could not decompose, especially the high density electron clouds compound. Therefore, the treatment range of the present invention is broadened.

6. The present invention could perform the waste water treatment in a limited space. The treatment system of the present invention is eagerly been required by the waste water having high colority of the dye manufacturing factory, the waste water having the biologically toxicity of petrochemical industry and paper-milling industry, and the leachate waste water from the garbage land filled area, etc.

In view of the foregoing, in the present invention, by way of filling the catalyst 5 and introducing air and current into the treatment tank 2, Hydrogen Peroxide is produced in the treatment tank 2, and which reacts with the dissolved Ferrous ions in the treatment tank 2 to rapidly generate a certain quantity of Hydroxyl radicals (·OH), so as to degrade and mineralize the organic compounds in the waste water to CO₂ and H₂O, without dosing Hydrogen Peroxide and Ferrous Sulfate. Moreover, it is not necessary to continuously dose or recover the catalyst 5, so that the life cycle of the catalyst 5 is extended. It is easy to operate the present treatment process, and the reaction time and operation cost thereof are significantly reduced.

The preferred embodiments are only used to illustrate the present invention, not intended to limit the scope thereof. Many modifications of the preferred embodiments can be made without departing from the spirit of the present invention.

What is claimed is:

1. A catalytic electrochemistry waste water treatment process, comprising:
(a) filling a catalyst in a treatment tank, and filling the waste water into said treatment tank from a waste water tank;
(b) disposing a positive electrode plate and a negative electrode plate in said treatment tank, and conducting said positive electrode plate and said negative electrode plate with current, and feeding air into the air tube in said treatment tank;
(c) Hydrogen Peroxide (H₂O₂) produced in said treatment tank by reaction of catalyst, air, and electricity reacting with Ferrous ions dissolved in said treatment tank to rapidly generate a certain quantity of Hydroxyl radicals (·OH), said Hydroxyl radicals produced by a reaction of said catalyst with said air and said conducting current, thereby the organic compounds of said waste water are degraded or mineralized to CO₂ and H₂O;
(d) feeding the treated water into a collecting tank from said treatment tank.

2. The process as claimed in claim 1, wherein said Ferrous ions dissolved in said treatment tank are obtained from said catalyst dissolved therein.

3. The process as claimed in claim 1, wherein the waste water is performed pH pre-adjustment prior to treatment.

4. A catalytic electrochemistry waste water treatment apparatus, comprising:
a treatment tank, having a predetermined dimension, said treatment including at least a water inlet and a water outlet;
a waste water tank, provided for containing waste water to be treated, said waste water tank connected with said water inlet of said treatment tank, and pumping the waste water into said treatment tank through at least a waste water pump, a flow meter provided for controlling the flow quantity; and
a collecting tank, provided for containing the treated outlet water, said collecting tank connected with said water outlet of said treatment tank; which characterized in that:
at least a positive electrode plate and a negative electrode plate, both of which having conductivity, said positive electrode plate and said negative electrode plate disposed in a respective predetermined position of said treatment tank, said two electrode plates respectively connected with an electricity power source and respectively conducting with positive and negative electricity current;
at least a catalyst, filled in said treatment tank, said water inlet and said water outlet of said treatment tank respectively disposed in the top and bottom of said tank; and
an air unit, including an air compressor and an air tube, said air tube disposed in said treatment tank, a plurality of diffusers disposed on said air tube, the diameter and distribution of said diffusers being set in coordination with said treatment tank.

5. The apparatus as claimed in claim 4, wherein a inclined plate is disposed in the bottom of said treatment tank, a plurality of waste pipes disposed in respective predetermined position of said inclined plate.

6. The apparatus as claimed in claim 4, wherein an inlet water spreading tube is disposed nearby said water inlet of said waste water tank.

7. The apparatus as claimed in claim 4, wherein a siphon breaking device is disposed in said collecting tank.

8. The apparatus as claimed in claim 4, wherein said water inlet is disposed in the top of said treatment tank, and both of said water outlet and said air tube are disposed in the bottom of said treatment tank.

9. The apparatus as claimed in claim 4, wherein the maximum distance between said positive electrode plate and said negative electrode plate is about 1.2 meters.
